(19) United States
(12) Patent Application Publication
(10) Pub. No.: US 2007/0059992 A1
(43) Pub. Date: Mar. 15, 2007

(54) COIL TERMINAL ASSEMBLY FOR MAGNETIC CONTACTOR

(75) Inventor: Jun-Ho KIM, Daejeon (KR)

Correspondence Address: GREENBLUM & BERNSTEIN, P.L.C., 1950 ROLAND CLARKE PLACE, RESTON, VA, 20191, US

(73) Assignee: LS INDUSTRIAL SYSTEMS CO., LTD., Seoul (KR)

(21) Appl. No.: 11/470,392

(22) Filed: Sep. 6, 2006

(30) Foreign Application Priority Data
Sep. 13, 2005 (KR) 10-2005-0085351

(51) Int. Cl. H01R 4/36

(52) U.S. Cl. 439/810

(57) ABSTRACT

A coil terminal assembly for a magnetic contactor comprises: a coil terminal connected to the coil and electrically connected to an external wire, for magnetizing the coil thereby driving the movable contact; a connection supporting member having a top portion having a threaded screw connection portion, a body portion having an opening through which the coil terminal and the external wire are inserted and providing a space in which the coil terminal and the external wire are electrically connected to each other, and a bottom portion formed as a concave surface inclined towards a center portion, the connection supporting member movable to a position for pressurizing the external wire so as to maintain an electrical connection between the external wire and the coil terminal, and movable to a position for separating the external wire from the coil terminal; and a driving screw having a threaded surface meshed with the screw connection portion, for driving the connection supporting member along the threaded surface.

### RELATED APPLICATION

The present disclosure relates to subject matter contained in priority Korean Application No. 10-2005-0085351, filed on Sep. 13, 2005, which is herein expressly incorporated by reference in its entirety.

### BACKGROUND OF THE INVENTION

1. Field of the Invention

The present invention relates to a coil terminal assembly for a magnetic contactor, and more particularly, to a coil terminal assembly for a magnetic contactor capable of preventing an external wire from being separated from a connection supporting member which connects a coil terminal of the magnetic contactor to the external wire, and capable of preventing a difficult driving of a driving screw which vertically moves the connection supporting member resulting from an inclination of the connection supporting member when a thick wire is used as the external wire.

2. Description of the Background Art

Generally, a magnetic contactor includes a switching mechanism having a stationary contact and a movable contact, the movable contact moved to contact or be separated from the stationary contact; and a coil for providing a magnetic driving force to drive the movable contact.

The magnetic contactor has a spring for elastically-biasing the movable contact to a position separated from the stationary contact. When a control current is supplied to the coil of the magnetic contactor thus to magnetize the coil and to overcome the elastic bias force of the spring, the movable contact is moved to a position contacting the stationary contact. On the contrary, when the control current flowing on the coil is cut off thus to demagnetize the coil, the movable contact is moved to a position separated from the stationary contactor by the elastic bias force of the spring.

The present invention relates to a coil terminal assembly for connecting a coil terminal of a magnetic contactor to an external wire for a control current supply. The related art coil terminal assembly will be explained with reference to FIG. 1.

FIG. 1 is a exploded perspective view showing a coil terminal assembly for a magnetic contactor in accordance with the related art.

As shown the related art coil terminal assembly for a magnetic contactor comprises a driving screw 30. The driving screw 30 includes a head portion 31 having a groove to which a screw drive is connected, a body portion 32 having a thread, and an anchor portion 33 formed at a lower portion thereof.

The coil terminal assembly comprises a connection supporting member (so called as a rug box) 10 having a top portion and a bottom portion. The top portion is provided with a thread portion 10a forming a driving screw connection hole 10c and movable in upper and lower directions along a thread of the body portion 32 of the driving screw 30 in accordance with a rotation of the driving screw 30. An anchor hole 10b for inserting the anchor portion 33 of the driving screw 30 is provided at the bottom portion of the connection supporting member 10.

The coil terminal assembly comprises a coil terminal 20 having a screw through hole 21 connected to the driving screw connection hole of the connection supporting member 10, and having one end (not shown) connected to the coil and the other end to be inserted into the connection supporting member 10.

The connection supporting member 10 is formed as a rectangular metal cylinder. When the connection supporting member 10 is installed in the magnetic contactor, a surface of the connection supporting member 10 facing an inner part of the magnetic contactor is opened thus to insert the coil terminal 20. Herein, opposite surface to said surface of the connection supporting member 10 is also opened thus to insert an external wire for controlling the coil. The connection supporting member 10 is constructed so that the inner facing surfaces and the opposite surfaces nay be connected to each other.

The coil terminal 20 is a plate-type electric conductor, and has at least one end inserted into the connection supporting member 10 thus to be electrically connected to the external wire. The screw through hole 21 having a diameter larger than that of the anchor portion 33 of the driving screw 30 but smaller than that of the body portion 32 is provided at a plate surface of the coil terminal 20. The screw through hole 21 is aligned to be connected to the driving screw connection hole 10c and the anchor hole 10b of the connection supporting member 10.

The driving screw 30 consists of a head portion 31; a body portion 32 having a diameter smaller than that of the head portion 31, and downwardly extending from the head portion 31 by a preset length; and an anchor portion 33 extending from the body portion 32 by a preset length.

In the coil terminal assembly for a magnetic contactor, an operation for connecting an external wire having a ring terminal to the coil terminal 20 will be explained.

Under a state that the screw through hole 21 of the coil terminal 20, the driving screw connection hole 10c of the connection supporting member 10, and the anchor hole 10b of the connection supporting member 10 are aligned to connect to one another, the ring terminal of the external wire is inserted into a lower surface of the coil terminal 20 through the opening of the connection supporting member 10.

Then, a screw driver is inserted into a driving screw support hole (not shown) formed at a side surface of the magnetic contactor and having a diameter larger than that of the head portion 31. Then, the driving screw 30 is clockwise rotated with using the screw driver.

Accordingly, the connection supporting member 10 is upwardly moved along the thread of the body portion 32 of the driving screw 30.

The head portion 31 of the driving screw 30 is prevented from being separated from the magnetic contactor since the driving screw support hole having a diameter larger than that of the head portion 31 and having a length longer than that of the head portion 31 is formed at a side surface of the magnetic contactor.

When the driving screw 30 is more rotated in a clockwise direction, the ring terminal of the external wire is compressed between an inner bottom surface of the connection supporting member 10 and the coil terminal 20. Then, the anchor portion 33 of the driving screw 30 is inserted into the ring terminal of the external wire and the anchor hole 10b formed at the bottom surface of the connection supporting member 10, thereby preventing the ring terminal of the external wire from being separated from the connection supporting member.

However, in the related art coil terminal assembly for a magnetic contactor, when the external wire is a general conductive wire having a cylindrical section and having an insulation layer coated on a conductive wire, or a wire having a ‘U’-shaped terminal, a following problem is caused.

When the external wire is pulled out after being connected to the coil terminal 20, it is easily separated from the coil terminal 20.

The reason is because a lower surface of the coil terminal 20 and an inner lower surface of the connection supporting member 10 are flat, and an additional means for fixing the external Wire is not provided.

Furthermore, when an external wire having a large diameter and a heavy weight is inserted into the connection supporting member 10, the external wire may be inserted thereto with unbalance since the inner bottom surface of the connection supporting member 10 is flat as shown in FIG. 1. Accordingly, the connection supporting member 10 is slanted in one direction due to the heavy weight of the external wire. As the result, a screw thread of the body portion 32 of the driving screw 30 is not completely meshed to the thread portion 10a of the connection supporting member 10, thereby cause a difficulty in rotating the driving screw 30.

### SUMMARY OF THE INVENTION

Therefore, an object of the present invention is to provide a coil terminal assembly for a magnetic contactor capable of preventing a connection supporting member from being slanted in one direction when a thick external wire is inserted to or separated from the connection supporting member.

To achieve these and other advantages and in accordance with the purpose of the present invention, as embodied and broadly described herein, there is provided a coil terminal assembly for a magnetic contactor comprising: a switching mechanism having a stationary contact and a movable contact, the movable contact moved to contact or be separated from the stationary contact; and a coil for providing a magnetic driving force to drive the movable contact, the coil terminal assembly comprising: a coil terminal connected to the coil and electrically connected to an external wire, for magnetizing the coil thereby driving the movable contact; a connection supporting member having a top portion having a threaded screw connection portion, a body portion having an opening through which the coil terminal and the external wire are inserted and providing a space in which the coil terminal and the external wire are electrically connected to each other, and a bottom portion formed as a concave surface inclined towards a center portion, the connection supporting member movable to a position for pressurizing the external wire so as to maintain an electrical connection between the external wire and the coil terminal, and movable to a position for separating the external wire from the coil terminal; and a driving screw having a threaded surface meshed with the screw connection portion, for driving the connection supporting member along the threaded surface.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a exploded perspective view showing a coil terminal assembly for a magnetic contactor in accordance with the related art;

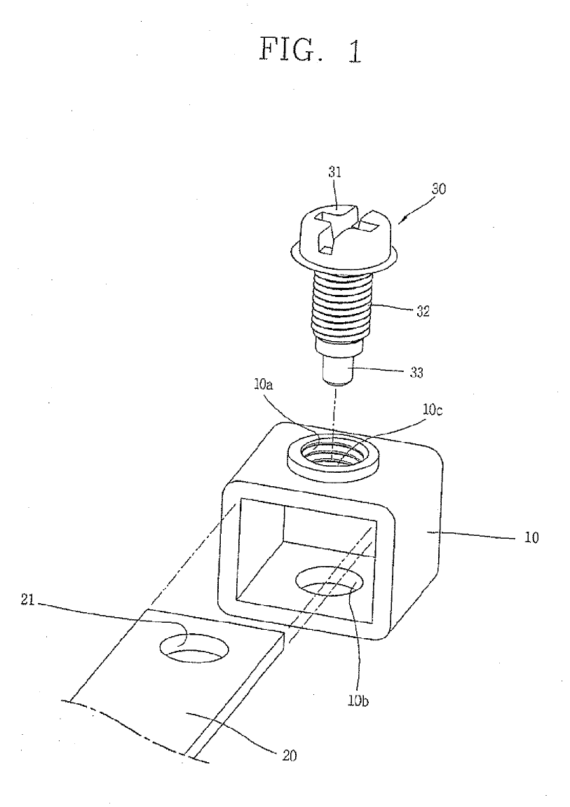

FIG. 2 is a exploded perspective view showing a coil terminal assembly for a magnetic contactor according to an embodiment of the present invention;

FIG. 3 is a perspective view showing an assembled state of the coil terminal assembly for a magnetic contactor according to the embodiment of the present invention;

FIG. 4 is a perspective view showing a magnetic contactor having the coil terminal assembly according to a first embodiment of the present invention; and

FIG. 5 is a perspective view showing a coil mechanism of the magnetic contactor having the coil terminal assembly according to the embodiment of the present invention, and external wires connected to a coil terminal.

### DETAILED DESCRIPTION OF THE INVENTION

Reference will now be made in detail to the preferred embodiments of the present invention, examples of which are illustrated in the accompanying drawings.

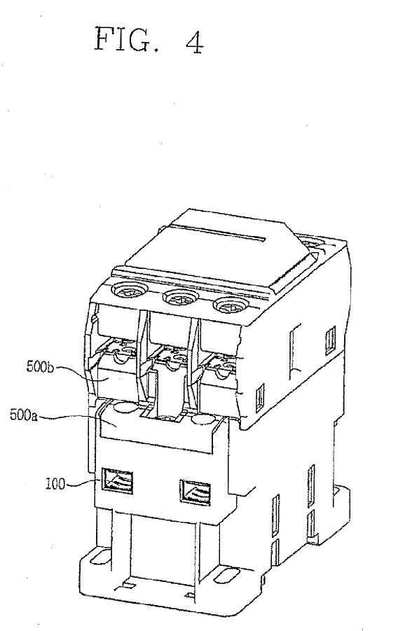

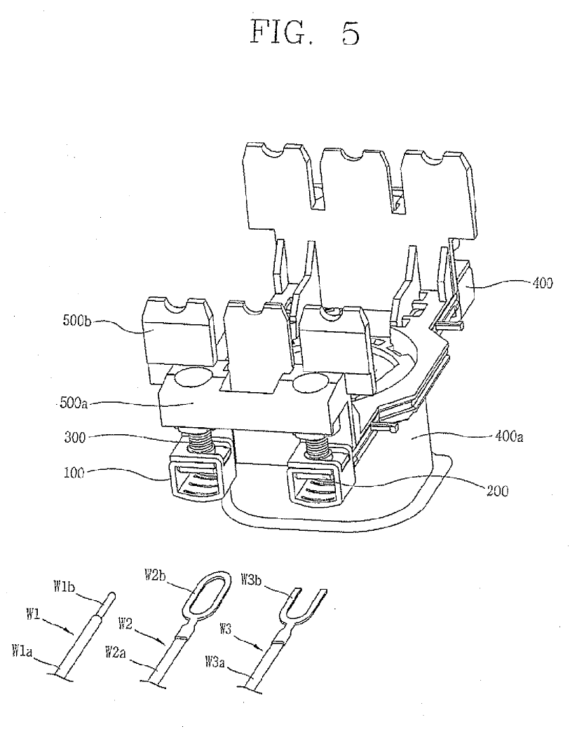

A coil terminal assembly for a magnetic contactor according to the present invention is installed at a magnetic contactor. The magnetic contactor includes a well known conductive portion (not shown) having a stationary contact (not shown) and a movable contact (not shown) movable to contact or be separated from the stationary contact, and a coil mechanism (refer to numeral 400 in the FIG. 5) for providing a driving force to drive the movable contact. And the external shape of the magnetic contactor according to the present invention can be referred to FIG. 4.

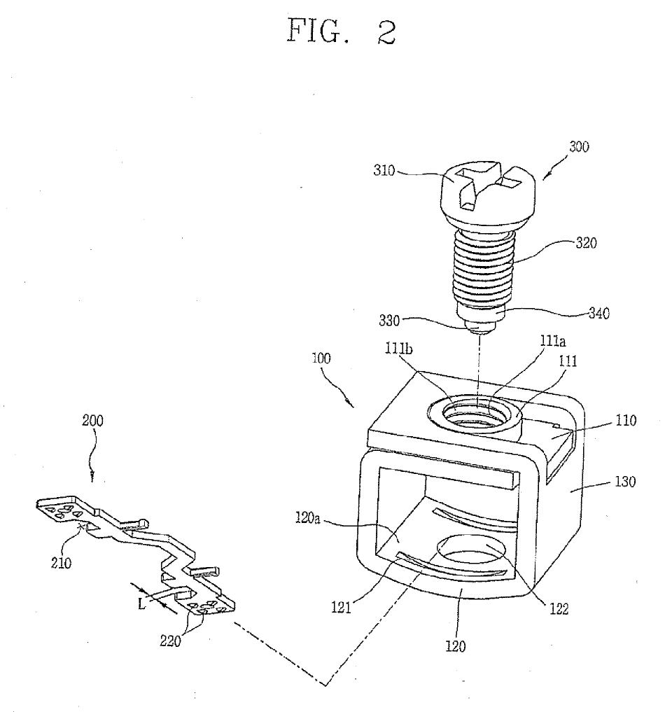

Referring to FIG. 2, the coil terminal assembly for a magnetic contactor according to the present invention comprises a coil terminal 200. The coil terminal 200 is connected to a coil 400a of the coil mechanism 400 in FIG. 5. The coil terminal 200 can be electrically connected to an external wire (W1 to W3 of FIG. 5) in order to drive the movable contact by magnetizing the coil.

The external wire may be a wire W2 having a ring-shaped terminal W2a, or a wire W3 having a U-shaped terminal W3b, or a wire W1 having a metal conducting wire W1b therein and coated with an insulating material W1a.

The coil terminal assembly for a magnetic contactor according to the present invention includes a connection supporting member 100 movable to a position to pressurize the external wire so as to maintain an electric connection between the external wire and the coil terminal 200 or to a position to release the external wire from the coil terminal 200 so as to separate the external wire from the coil terminal 200.

The connection supporting member 100 comprises a top portion 110 having a screw connection portion 111 provided with a thread 111a; a body portion 130 having an opening for inserting the coil terminal 200 and the external wire and providing a space to electrically connect the coil terminal 200 and the external wire to each other; and a bottom portion 120 having an inner bottom concaved surface 120a inclined towards a center for guiding the external wire with balance.

The coil terminal assembly for a magnetic contactor according to the present invention comprises a driving screw 300. The driving screw 300 has a threaded surface 320 meshed with the screw connection portion 111 of the connection supporting member 100. The driving screw 300 can drive the connection supporting member 100 to be moved along the threaded surface 320.

The connection supporting member 100 is constructed as a rectangular cylinder formed by bending a belt-shaped metal strip four times. The top portion 110 of the connection supporting member 100 facing the bottom portion 120 in a longitudinal direction of the connection supporting member 100 is provided with a driving screw connection hole 111b. The thread 111a is provided at an inner circumferential surface of the driving screw connection hole 111b.

An anchor hole 122 is provided at the inner bottom surface 120a of the bottom portion 120 of the connection supporting member 100.

A stop recess 121 having a length in a crossing direction with an insertion direction of the external wire is formed at the inner bottom surface 120a of the connection supporting member 100, thereby preventing the external wire from being separated easily therefrom. The stop recess 121 prevents the external wire from being separated easily therefrom by forming the inner bottom surface 120a of the connection supporting member 100 as a convex-concave surface. In the present invention, two recesses 121 are formed on a back position and a forth position on the basis of the anchor hole 122. However, a modified embodiment which additionally form one stop recess 121 instead of the anchor hole 122 is also possible.

Referring to FIG. 2, the connection supporting member 100 has a cylinder structure penetrated in two directions. Accordingly, when the connection supporting member 100 is installed in the magnetic contactor, the coil terminal 200 is inserted into the connection supporting member 100 in one direction and the external wire is inserted into the connection supporting member 100 in the other direction.

The coil terminal 200 is constructed as a metallic electrical conductive member having a plate shape.

One end of the coil terminal 200 in a longitudinal direction is inserted into the connection supporting member 100 thus to be connected to the external wire, so that the external wire is electrically connected to the coil 400a.

As shown in FIG. 2A, one end of the coil terminal 200 is inserted into the connection supporting member 100, and a connection recess 210 for passing the driving screw 300 extending through the driving screw connection hole 111b of the connection supporting member 100 is formed at said one end of the coil terminal 200.

A plurality of protrusions 220 for preventing the external wire from being separated therefrom by enhancing a frictional force with the external wire are protruding from one plate surface of the coil terminal 200.

As shown in FIG. 5, the coil terminal 200 is fixed at an upper portion of a bobbin (numeral is not designated) of the coil mechanism 400, and a middle portion thereof is connected to the coil 400a wound on the bobbin.

The construction of the driving screw 300 will be explained in more detail.

Referring to FIG. 2, the driving screw 300 comprises a head portion 310, and a body portion extending from the head portion 310 and having a diameter smaller than that of the head portion 310. A ‘+’ shaped groove for rotating the driving screw 300 with using a tool such as a screw driver is formed on an upper surface of the head portion 310. The threaded surface 320 is formed on an outer circumferential surface of the body portion of the driving screw 300 so as to be meshed with the thread 111a of the connection supporting member 100. A terminal contact portion 340 having a diameter smaller than that of the boy portion and having a flat outer circumferential surface and a predetermined length is extending from a lower end of the body portion. The lower end of the terminal contact portion 340 comes in contact with an upper surface of the coil terminal 200. An anchor portion 330 having a diameter smaller than that of the terminal contact portion 340 and having a flat outer circumferential surface is extending from a lower end of the terminal contact portion 340. The anchor portion 330 passes through the connection recess 210 of the coil terminal 200. When the external wire is an external wire W2 having a ring-shaped terminal, the anchor portion 330 may be inserted into the anchor hole 122 of the inner bottom surface 120 of FIG. 2 via a center hole of the ring-shaped terminal W2b.

A length L of the connection recess 210 of the coil terminal 200 is smaller than an outer diameter of the terminal contact portion 340 and is larger than an outer diameter of the anchor portion 330, thereby passing only the anchor portion 330 of the driving screw 300.

The coil mechanism 400 to which the coil terminal assembly for a magnetic contactor according to the present invention is connected will be explained with reference to FIG. 5.

The coil mechanism 400 is provided with a guiding groove formed at an upper side surface of the bobbin, and two coil terminals 200 are inserted into the guiding groove.

The coil terminal 200 is provided with a coil connection portion connected to one end of the coil 400a at a middle portion thereof. At least one end of both ends of each coil terminal 200 is inserted into the connection supporting member 100 thus to come in contact with a part of the driving screw 300.

A terminal cover 500a is installed above the driving screw 300. The terminal cover 500a rotatably supports the head portion 310 of the driving screw 300. Also, the terminal cover 500a has guiding holes for inserting a screw driver and guiding the screw driver to be connected to the head portion of the driving screw 300 and circular walls for forming the guiding holes in correspondence with the number of the coil terminals 200. A dust cover 500b for shielding a front side of a line connection terminal from dust, etc. to which an electric line (three-phase line, etc.) opened or closed electrically by the magnetic contactor is provided on the terminal cover 500a in correspondence with the number of the lines.

As shown in FIG. 4, the connection supporting member 100, the terminal cover 500a, and the dust cover 500b are sequentially installed at a middle portion of the magnetic contactor.

An operation to connect/separate the magnetic contactor to/from the external wire will be explained.

An operation to connect the external wire W2 having a ring terminal W2b to the coil terminal assembly for a magnetic contactor will be explained.

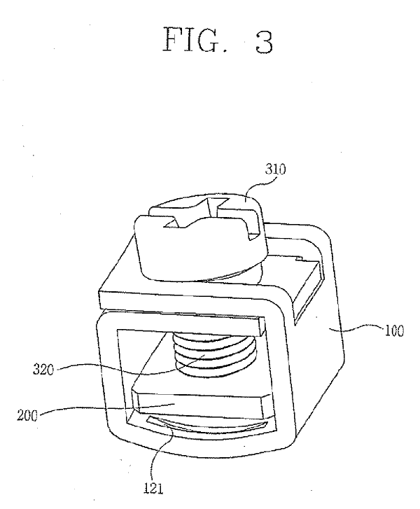

As shown in FIG. 5, under a state that a space between the inner bottom surface 120a of the connection supporting member 100 and the coil terminal 200 is obtained accordingly as the connection supporting member 100 is lowered by rotation of the driving screw 300, the ring-shaped terminal W2b of the external wire W2 is inserted into the space between said one end of the coil terminal and the bottom portion 120 of the connection supporting member 100 through an opening. Then, the driving screw 300 is clockwise rotated, so that the connection supporting member 100 is upwardly moved along the thread of the driving screw 300 (state of FIG. 3). As the driving screw 300 is clockwise rotated, the ring-shaped terminal W2b of the external wire W2 is inserted between the concaved portion of the inner bottom surface of the connection supporting member 100 and the lower surface of the coil terminal 200. Accordingly, the external wire and the coil terminal 200 are electrically connected to each other.

An operation to separate the coil terminal assembly for a magnetic contactor and the external wire from each other is performed in the opposite manner to the aforementioned connection operation therebetween.

More concretely, under a state that the external wire and the coil terminal 200 are electrically connected to each other, the driving screw 300 is counterclockwise rotated by a screw driver. As the result, the connection supporting member 100 is downwardly moved along the threaded surface 320 of the driving screw 300.

As the driving screw 300 is counterclockwise rotated, a space is formed between the concaved portion of the inner bottom surface of the connection supporting member 100 and the lower surface of the coil terminal 200. Under a state that the relative position between the driving screw 300 and the coil terminal 200 is not changed, only the connection supporting member 100 is vertically moved accordingly as the driving screw 300 is rotated. That is, the mounted state of the lower end of the terminal contact portion 340 of the driving screw 300 to a peripheral surface of the connection recess 210 of the coil terminal 200 is maintained irrespective of the rotation of the driving screw 300.

As the space is formed, the external wire having a ring-shaped terminal or the external wire having a ‘U’-shaped terminal, or the metal conductive wire is released thus to be separated from the coil terminal 200.

When the wire W1 having an insulating coat W1a and a metal conducting wire W1b or the wire W3 having a ‘U’-shaped terminal W3b at one end thereof is used as the external wire, a contact area between an upper surface of the external wire and the coil terminal 200 and a contact area between a lower surface of the external wire and the bottom portion 120 of the connection supporting member 100 are more increased than those of the related art due to the stop recess 121 of the inner bottom surface 120 of the connection supporting member 100. Accordingly, the external wire is prevented from being separated unintentionally from the coil terminal 200.

Furthermore, when the wire W1 having a thick metal conducting wire W1b is used as the external wire, the wire W1 can be guided to be positioned at a center of the bottom surface of the connection supporting member 100 with balance due to the concaved bottom portion 120 of the connection supporting member 100. Accordingly, a problem caused at the time of tightening or loosening the driving screw 300 due to an inclination of the connection supporting member 100 can be prevented.

As aforementioned, a contact area between the upper surface of the external wire and the coil terminal and a contact area between the lower surface of the external wire and the bottom portion of the connection supporting member are more increased than those of the related art due to the recess of the inner bottom surface of the connection supporting member and the protrusion formed at one surface of the coil terminal. Accordingly, the external wire is prevented from being separated unintentionally from the coil terminal.

Furthermore, when a thick wire is used as the external wire, the thick wire is guided to be positioned with balance at a center of the bottom portion of the connection supporting member since the bottom portion is constructed as a concaved surface inclined toward the center. Accordingly, a problem caused at the time of tightening or loosening the driving screw due to an inclination of the connection supporting member resulting from an unbalanced insertion of the thick wire can be prevented.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A coil terminal assembly for a magnetic contactor comprising: a switching mechanism having a stationary contact and a movable contact, the movable contact moved to contact or be separated from the stationary contact; and a coil for providing a magnetic driving force to drive the movable contact, the coil terminal assembly comprising:
a coil terminal connected to the coil and electrically connected to an external wire, for magnetizing the coil thereby driving the movable contact;
a connection supporting member having a top portion having a threaded screw connection portion, a body portion having an opening through which the coil terminal and the external wire are inserted and providing a space in which the coil terminal and the external wire are electrically connected to each other, and a bottom portion formed as a concave surface inclined towards a center portion, the connection supporting member movable to a position for pressurizing the external wire so as to maintain an electrical connection between the external wire and the coil terminal, and movable to a position for separating the external wire from the coil terminal; and
a driving screw having a threaded surface meshed with the screw connection portion, for driving the connection supporting member along the threaded surface.

2. The coil terminal assembly of claim 1, wherein the coil terminal is provided with a plurality of protrusions at one plate surface thereof so as to enhance a frictional force with the external wire.

3. The coil terminal assembly of claim 1, wherein a recess having a length in a crossing direction with an insertion direction of the external wire is formed at the inner bottom surface of the connection supporting member so as to prevent the external wire from being separated therefrom.

4. The coil terminal assembly of claim 1, wherein the connection supporting member is configured as a rectangular metal cylinder formed by bending a metal piece of a long belt shape.
